(19) United States
(12) Patent Application Publication
(10) Pub. No.: US 2015/0077645 A1
(43) Pub. Date: Mar. 19, 2015

(54) IMAGE-PROJECTION MODULE

(71) Applicant: Lite-On Technology Corporation, Taipei (TW)

(72) Inventor: Wei-Chih LIN, Taipei (TW)

(21) Appl. No.: 14/296,410

(22) Filed: Jun. 4, 2014

(30) Foreign Application Priority Data
Sep. 18, 2013 (CN) 201310426332.1

(51) Int. Cl. G02F 1/01; G02F 1/13; H04N 9/31

(52) U.S. Cl. CPC G02F 1/0136; H04N 9/3129; G02F 1/1313
USPC 349/9; 353/20

(57) ABSTRACT

The invention discloses an image-projection module, which includes a light source assembly, a light polarization switching element, and a light-path switching assembly. The light source assembly generates a laser light beam. The light polarization switching element is configured to make the laser light beam passing therethrough to selectively have a first polarizing direction or a second polarizing direction. The light-path switching assembly receives the laser light beam passing through the light polarization switching element and determines a projection direction of the laser light beam according to the polarizing direction of the laser light beam.

### CROSS REFERENCE TO RELATED APPLICATIONS

This Application claims priority of China Patent Application No. 201310426332.1, filed on Sep. 18, 2013, the entirety of which is incorporated by reference herein.

### BACKGROUND OF THE INVENTION

1. Field of the Invention

The present invention relates to an image-projection module, and in particular to an image-projection module having a multi-directional projection function.

2. Description of the Related Art

An image-projection module is an electrical device that is used to project an image at a desired target for a viewer. Generally, conventional image-projection modules include a light source and an optical unit. After the light from the light source passes through the optical unit, a projected image is shown on the desired target. The conventional image-projection module provides the projection image along a single particular direction and has no multi-directional projection functionality. With advances in related techniques, the image-projection module has become even more compact. The image-projection module can not only be used alone, but as a component of a mobile electronic device, such a mobile phone, tablet computer, positioning device, etc. However, the image-projection module with single projection direction is not applicable for the advanced mobile electronic device. Therefore, development of an image-projection module having multi-directional projection function is provided by the manufacturers.

In a conventional multi-directional projection module, light is projected to two or more desired targets via an optical unit, so as to project an image along different directions. However, since the optical unit includes a large number of components, the manufacturing cost of the image-projection module is increased. In addition, since the structure of the optical unit is complex, the size of the image-projection module cannot be reduced.

In another conventional multi-directional projection module, an optical unit is moved in different positions by an actuator, so as to alter the light-path for projecting images along different directions. However, in order to allow the movement of the optical unit, extra space is needed to accommodate the actuator, which hinders the development of a light and compact electronic device.

### BRIEF SUMMARY OF THE INVENTION

The disclosure is directed to an image-projection module having multi-directional projection function. With a light-path switching unit and simple optical element, the image-projection module is capable of projecting images along multiple directions. In addition, the image-projection module can be operated in different operating modes, so as to meet the need to facilitate a variety of projection modes for the viewer.

According to one embodiment of the disclosure, the image-projection module includes a light source assembly, a light polarization switching element, and a light-path switching unit. The light source assembly generates a laser light beam. The light polarization switching element is configured to enable the laser light beam passing through the light polarization switching element to selectively have a first polarizing direction or a second polarizing direction. The light-path switching assembly receives the laser light beam passing through the light polarization switching element and determines the projection direction of the laser light beam according to the polarizing direction of the laser light beam.

In the aforementioned embodiments, when the laser light beam has the first polarizing direction, the laser light beam impinging the light-path switching unit has a first projection path, and when the laser light beam is in the second polarizing direction, the laser light beam impinging the light-path switching unit has a second projection path.

In the aforementioned embodiments, the image-projection module further includes a light scanning element. The light scanning element is configured to drive the laser light beam to scan in a two-dimensional direction. In addition, the light-path switching unit includes a polarizing beam splitter.

In the aforementioned embodiments, the light polarization switching element has a liquid-crystal panel including a liquid-crystal layer. With the control of the orientation of liquid-crystal cells in the liquid-crystal layer, the laser light beam passing through the liquid-crystal panel is in the first polarizing direction or the second polarizing direction.

In the aforementioned embodiments, the image-projection module further includes a control assembly. The control assembly controls the light polarization switching element and enables the laser light beam passing through the light polarization switching element to have the first polarizing direction or the second polarizing direction.

In some embodiments, the control assembly controls the light polarization switching element to enable the laser light beam passing through the light polarization switching element to be kept in the first polarizing direction or the second polarizing direction. With such control means, the laser light beam impinging the light-path switching unit correspondingly has a first projection path or a second projection path. Therefore, the image-projection module is correspondingly operated in a single direction projection mode having a first projection direction or operated in a single direction projection mode having a second projection direction.

In some embodiments, the control assembly controls the light polarization switching element at a switching frequency. With such control means, the laser light beam passing the light polarization switching element is in the first polarizing direction or the second polarizing direction alternately according to the switching frequency. In addition, the laser light beam impinging the light-path switching unit alternately has a first projection path or a second projection path. Therefore the image-projection module is correspondingly operated in a bi-directional projection mode having the first projection direction and the second projection direction.

In the aforementioned embodiments, the switching frequency of the control assembly corresponds to a time period during which the light scanning element scans a whole image frame in the two-dimensional direction by the laser light beam.

According to another embodiment of the disclosure, the image-projection module includes a light source assembly, a light polarization switching element, and a control assembly. The light source assembly generates a laser light beam. The light polarization switching element is configured to make the laser light beam passing through the light polarization switching element to selectively have a first polarizing direction or a second polarizing direction. The control assembly controls the light polarization switching element at a switching frequency. The laser light beam passing through the light polarization switching element is polarized in the first polarizing direction or the second polarizing direction according to the switching frequency.

In the aforementioned embodiments, the image-projection module further includes a light-path switching unit. The light-path switching unit is configured to receive the laser light beam from the light polarization switching element and determine a projection path of the laser light beam according to the polarizing direction of the laser light beam.

The image-projection module projects an image in different directions according to the polarizing direction of the laser light beam. Therefore, the integrity is improved. In addition, since the image-projection module needs no complex components, the size of the image-projection module is decreased.

### BRIEF DESCRIPTION OF THE DRAWINGS

The invention can be more fully understood by reading the subsequent detailed description and examples with references made to the accompanying drawings.

FIG. 1 shows a block diagram of an image-projection module, in accordance with an embodiment.

FIG. 2 shows a schematic view of an image-projection module, in accordance with first embodiment.

FIG. 3 shows a cross-sectional schematic view of an LC panel, in accordance with an embodiment.

FIG. 4 shows a schematic view of an image-projection module, in accordance with second embodiment.

FIG. 5 shows a schematic view of an image-projection module, in accordance with third embodiment.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

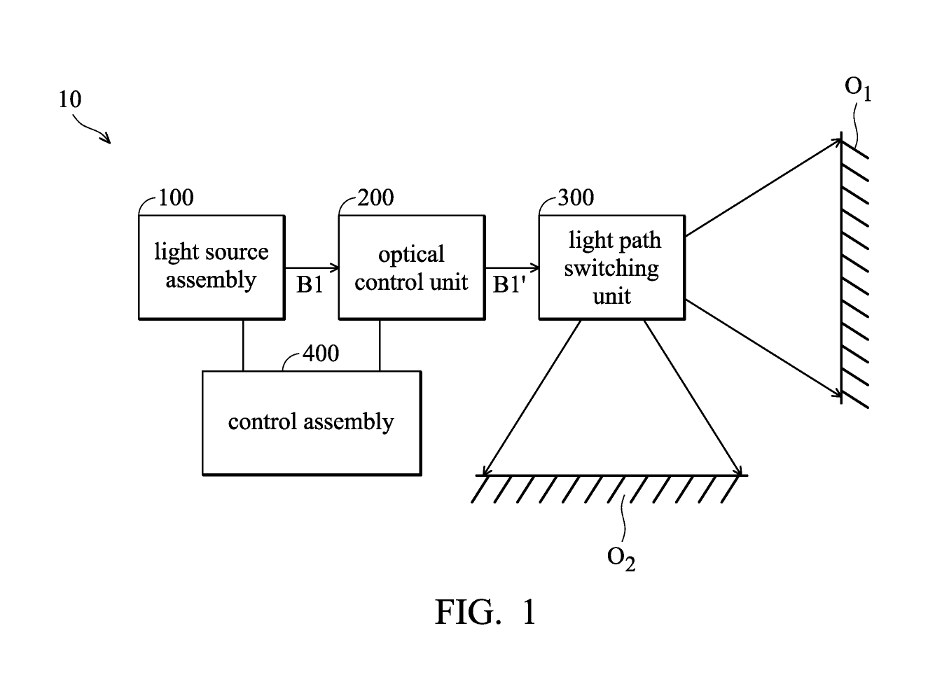

Referring to FIG. 1, a block diagram of an image-projection module is shown, in accordance with an embodiment. The image-projection module 10 includes a light source assembly 100, an optical control unit 200, a light-path switching unit 300, and a control assembly 400. The control assembly 400 is configured to control the light source assembly 100 and the optical control unit 200. The light source assembly 100 is configured to generate a laser light beam B1. The optical control unit 200 includes a light polarization switching element and a light scanning element. After the laser light beam B1 from the light source assembly 100 impinges the optical control unit 200, the laser light beam B1 is scanned across in a two-dimensional direction by the light scanning element. The polarization direction of the laser light beam B1 is converted by the light polarization switching element so that a polarized laser light beam B1′ is provided. The polarized laser light beam B1′ from the optical control unit 200 is redirected by the light-path switching unit 300 to different desired targets (e.g., a first desired target O1 or a second desired target O2) in accordance with the polarized direction of the polarized laser light beam B1′.

The structural features of the light source assembly 100, the optical control unit 200, and the light-path switching unit 300 are described in more detail below.

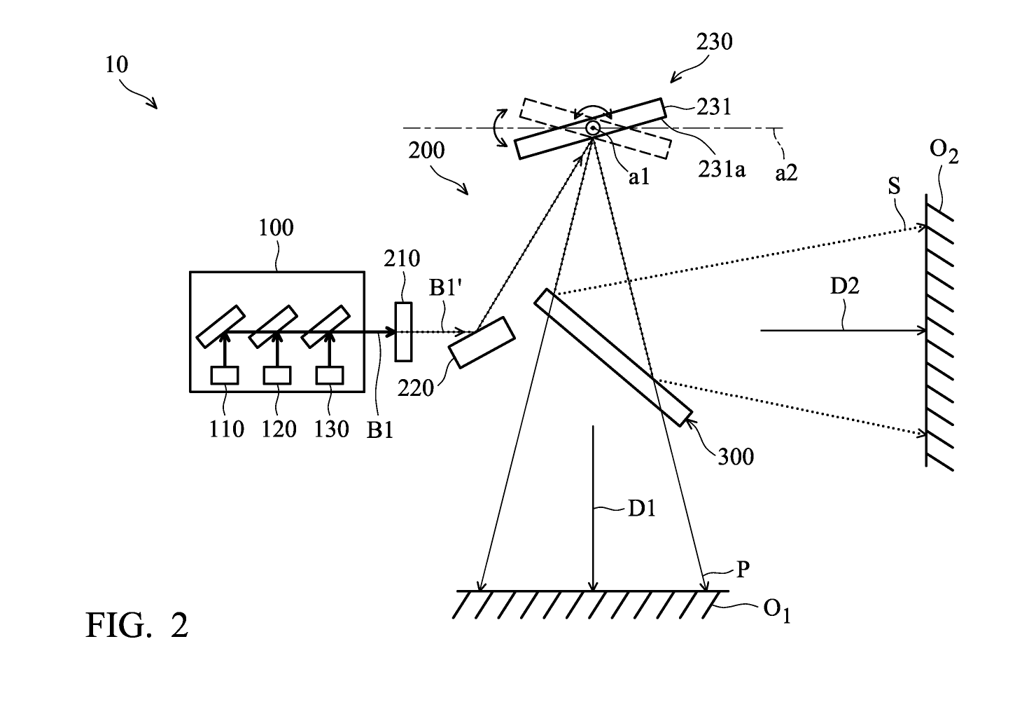

Referring to FIG. 2, a schematic view of an image-projection module is shown, in accordance with first embodiment of the present disclosure. In the embodiment, the light source assembly 100 includes three light emitting elements 110, 120, and 130. The three light emitting elements 110, 120, and 130 are laser diodes. The three light emitting elements 110, 120, and 130 may emit light in different wavelengths. For example, in the application of color image-projection, the light emitting element 110 emits red light, and the light emitting element 120 emits blue light, and the light emitting element 130 emits green light. The control of the three light emitting elements 110, 120, and 130 is carried out by the control assembly 400 in accordance with image data to be shown. By combining these three laser light beams from the three light emitting elements 110, 120, and 130, the laser light beam B1 containing the image data to be shown is projected to outside of the light source 100.

In the embodiment of the present disclosure, the optical control unit 200 includes a light polarization switching element 210 and a light scanning element 230. In the embodiment of the present disclosure, the light polarization switching element 210 is configured to convert the polarization direction of the laser light beam B1, and the light scanning element 230 is configured to drive light projected thereon to scan in a two-dimensional direction.

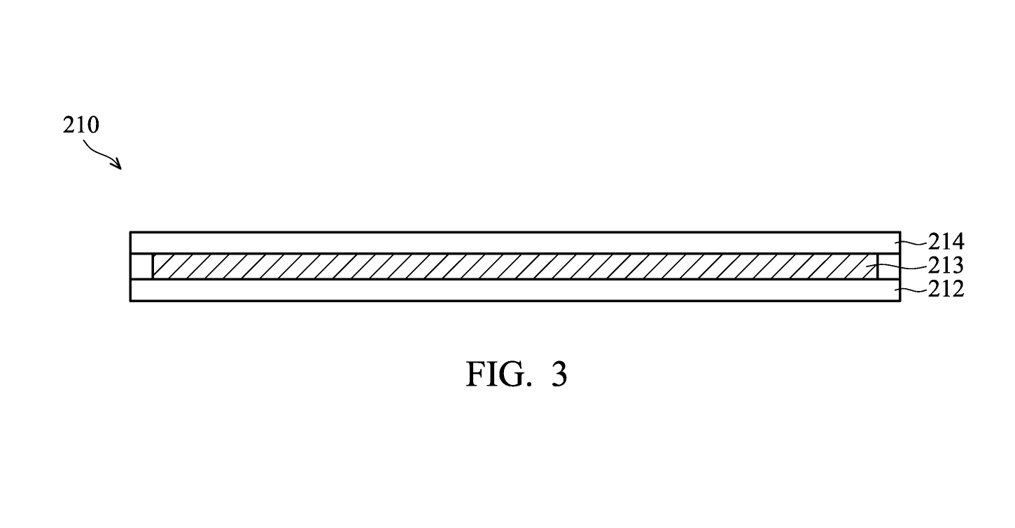

Referring to FIG. 3, a cross-sectional schematic view of the light polarization switching element 210 is shown, in accordance with an embodiment. In the embodiment of the present disclosure, the light polarization switching element 210 is a liquid-crystal panel and includes a first substrate 212, a liquid-crystal layer 213, and a second substrate 214. The liquid-crystal layer 213 is disposed between the first substrate 212 and the second substrate 214. In the embodiment of the present disclosure, the first and the second substrates 212 and 214 are transparent. By controlling the orientation of the liquid-crystal cells in the liquid-crystal layer 213, the light beam passing through the light polarization switching element 210 has a single particular polarizing direction.

Referring to FIG. 2 again, in the embodiment of the present disclosure, the optical control unit 200 further includes a reflective mirror 220. The reflective mirror 220 is configured to reflect the laser light beam to the light scanning element 230. The reflective mirror 220 is positioned between the light polarization switching element 210 and the light scanning element 230. The reflective mirror 220 is oriented obliquely to the light polarization switching element 210 at a predetermined angle so as to reflect the polarized laser light beam B1′ from the light polarization switching element 210 to the light scanning element 230.

In the embodiment of the present disclosure, the light scanning element 230 is a MEMS oscillatory mirror and includes one or more scanning plates 231 and one or more actuator (not shown in figures). The scanning plate 231 has a reflective surface 231a to reflect light projected thereon. The actuator is connected to the scanning plate 231 to control the position of the scanning plate 231 about the rotation axes a1 and a2. During operation, the reflected light from the scanning plate 231 is scanned on the desired target in a two-dimensional direction. The reflective surface 231a of the scanning plate 231 is made of material with a light reflection function. For example, the reflective surface of the scanning plate 231 is made of aluminium or gold or other metals with a light reflection function. The light scanning element 230 may scan the incident light in a Lissajous scanning pattern. Alternatively, the light scanning element 230 may scan the incident light in a Raster scanning pattern.

In the embodiment of the present disclosure, the light-path switching unit 300 is a polarizing beam splitter to redirect the incident light along different optical paths according the polarizing direction of the incident light. Specifically, the light-path switching unit 300 enables the polarized laser light beam with a first polarizing direction to be passed therethrough and reflects the polarized laser light beam with a second polarizing direction. The polarized laser light beam with a first polarizing direction and the polarized laser light beam with a second polarizing direction, for example, respectively are S-polarized light and P-polarized light. The P-polarized light has a polarizing direction perpendicular to that of the S-polarized light.

The operation method of the image-projection module 10, in accordance with the embodiment, is described below.

Referring to FIG. 2, in the embodiment of the present disclosure, with the light polarization switching element 210, the image-projection module 10 converts a laser light beam B1 to a polarized laser light beam B1′ with a desired polarizing direction. In addition, because the light-path switching unit 300 is capable of redirecting the polarized laser light beam B1′ to different optical paths according to the polarizing direction thereof, the polarized laser light beam B1′ is redirected along different projecting paths by the light-path switching unit 300. Therefore, the image-projection module 10 is able to selectively project an image on a first desired target O1 or a second desired target O2.

To project an image on the first desired target O1, a laser light beam B1 with image information is provided to the light polarization switching element 210 by the light source assembly 100 in accordance with image data. At the same time, the light polarization switching element 210 is controlled by the control assembly 400 to change the orientation of the liquid-crystal cells. As a result, the laser light beam B1 passing through the light polarization switching element 210 is polarized to a polarized laser light beam B1′ with a first polarizing direction (e.g., P-polarized light). The first polarizing direction corresponds to the first desired target O1.

Afterwards, the polarized laser light beam B1′ is reflected by the reflective mirror 220 to the reflective surface 231a of the light scanning element 230. The scanning plate 231 scans the polarized laser light beam B1′ that impinges on the reflective surface 231a along a particular pattern in a two-dimensional direction and projects the polarized laser light beam B1′ to the light-path switching unit 300. Afterwards, the polarized laser light beam B1′ with the first polarizing direction is redirected by the light-path switching unit 300 along a first projection path. For example, the polarized laser light beam B1′ with the first polarizing direction passes through the light-path switching unit 300 and is projected onto the first desired target O1 along the first direction D1.

Still referring to FIG. 2, to project an image on the second desired target O2, a laser light beam B1 with image information is provided to the light polarization switching element 210 by the light source assembly 100 in accordance with image data. At the same time, the light polarization switching element 210 is controlled by the control assembly 400 to change the orientation of the liquid-crystal cells. As a result, the laser light beam B1 passing through the light polarization switching element 210 is polarized to a polarized laser light beam B1′ with a second polarizing direction (e.g., S-polarized light). The second polarizing direction corresponds to the second desired target O2.

Afterwards, the polarized laser light beam B1′ is reflected by the reflective mirror 220 to the reflective surface 231a of the light scanning element 230. The scanning plate 231 scans the polarized laser light beam B1′ that impinges on the reflective surface 231a along a particular pattern in a two-dimensional direction and projects the polarized laser light beam B1′ to the light-path switching unit 300. Afterwards, the polarized laser light beam B1′ with the second polarizing direction is redirected by the light-path switching unit 300 along a second projection path. For example, the polarized laser light beam B1′ with the second polarizing direction is reflected by the light-path switching unit 300 and projected to the second desired target O2 along the second direction D2. In the embodiment, the first direction D1 is perpendicular to the second direction D2, as shown in FIG. 2.

In another embodiment of the present disclosure, the light polarization switching element 210 is controlled by the control assembly 400 to be alternately switched between a first operating mode and a second operating mode at a predetermined switching frequency. When the light polarization switching element 210 is in the first operating mode, the polarized laser light beam B1′ passing through light polarization switching element 210 is in the first polarizing direction (e.g., P-polarized light). The polarized laser light beam B1′ is redirected by the light-path switching unit 300 to the first desired target O1 along the first projection path. In addition, when the light polarization switching element 210 is in the second operating mode, the polarized laser light beam B1′ passing therethrough is in the second polarizing direction (e.g., S-polarized light). The polarized laser light beam B1′ is redirected by the light-path switching unit 300 to the second desired target O2 along the second projection path. If the switching frequency is high enough, the images produced by the image-projection module 10 are projected to the first desired target O1 and the second desired target O2 in a fast alternating manner. Therefore, the images projected on the first desired target O1 and the second desired target O2 can be simultaneously perceived by the viewer due to the persistence of vision.

In one embodiment of the present disclosure, the image-projection module 10 is arranged to simultaneously project the same image to the first desired target O1 and the second desired target O2. The image projected on the first desired target O1 is the same as the image projected on the second desired target O2. In another embodiment of the present disclosure, the image-projection module 10 is arranged to simultaneously project different images to the first desired target O1 and the second desired target O2. The image information of the laser light beam B1 emitted by the light source assembly 100 is controlled based on the switch frequency of the light polarization switching element 210. As a result, the image projected on the first desired target O1 is different from the image projected on the second desired target O2. In another embodiment of the present disclosure, the switching frequency of the light polarization switching element 210 corresponds the period during which the light scanning element 230 scans a whole image frame. Namely, once a whole image frame is scanned by the light scanning element 230 on the first desired target O1, the light polarization switching element 210 is switched to the other operating mode by the control assembly 400. The image-projection module 10 projects image to the second desired target O2 by the image-projection module 10. Additionally, once a whole image frame is scanned by the light scanning element 230 on the second desired target O2, the light polarization switching element 210 is switched to the previous operating mode by the control assembly 400, and the image is projected to the first desired target O1 again. Since the light scanning element 230 sequentially and repetitiously scans the image at high speed, the projected images on the first desired target O1 and the second desired target O2 can be simultaneously perceived by the viewer.

In the embodiment of the present disclosure, the control assembly 400 drives the light polarization switching element 210 to be switched between the first and second operating modes at a preset switching frequency so that the image-projection module 10 is able to project images to different desired targets at the same time. In addition, the control assembly 400 drives the light polarization switching element 210 to be maintained in the first operating mode or the second operating mode according to the user's selection, so that the image-projection module 10 is able to selectively project an image to one of the desired targets. Specifically, when the user sets the image being projected on the first desired target O1, the control assembly 400 controls the light polarization switching element 210 in the first operating mode. When the user sets the image being projected on the second desired target O2, the control assembly 400 controls the light polarization switching element 210 in the second operating mode. When the user sets the image being projected on the first desired target O1 and the second desired target O2 simultaneously, the control assembly 400 drives the light polarization switching element 210 to be alternately switched between a first operating mode and a second operating mode at a predetermined switching frequency.

In the embodiment of the present disclosure, with the control of the light polarization switching element 210 by the control assembly 400, the image-projection module 10 can be operated in a single direction projection mode to project the image in the first projection direction, or the image-projection module 10 can be operated in a single direction projection mode to project the image in the second projection direction, or the image-projection module 10 can be operated in a bi-directional projection mode to project the image in the first projection direction and the second projection direction.

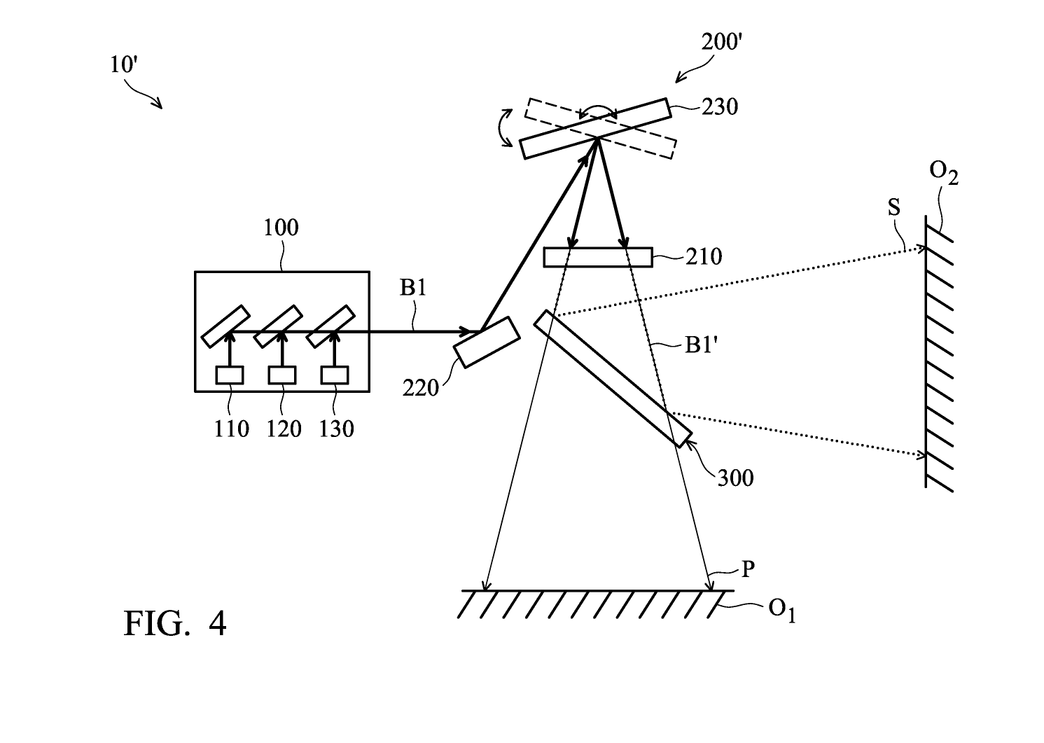

Referring to FIG. 4, a schematic view of an image-projection module 10′ in second embodiment is shown. In FIG. 4, similar elements which are shown in FIG. 2 are provided with the same reference numbers, and the features of similar elements are not repeated in the interests of brevity. Differences between the image-projection module 10′ and the image-projection module 10 includes that the light polarization switching element 210 of the optical control unit 200′ is positioned between the light scanning element 230 and the light-path switching unit 300.

In this case, the laser light beam B1 from the light source assembly 100 is directly projected on the reflective mirror 220 and reflected to the light scanning element 230. The light scanning element 230 drives the laser light beam B1 to scan in a two-dimensional direction and projects the laser light beam B1 to the light polarization switching element 210. The light polarization switching element 210 receives the laser light beam B1 and converts the laser light beam B1 into a polarized laser light beam B1′ with a particular polarizing direction. Afterwards, the light-path switching unit 300 receives the polarized laser light beam B1′ and redirects the polarized laser light beam B1′ along a projection path based on the polarizing direction of the polarized laser light beam B1′.

Similarly, in the embodiment of the present disclosure, with the control of the light polarization switching element 210 by the control assembly 400, the image-projection module 10′ can be operated in a single direction projection mode to project the image in the first projection direction, or the image-projection module 10′ can be operated in a single direction projection mode to project the image in the second projection direction, or the image-projection module 10′ can be operated in a bi-directional projection mode to project the images in the first projection direction and the second projection direction.

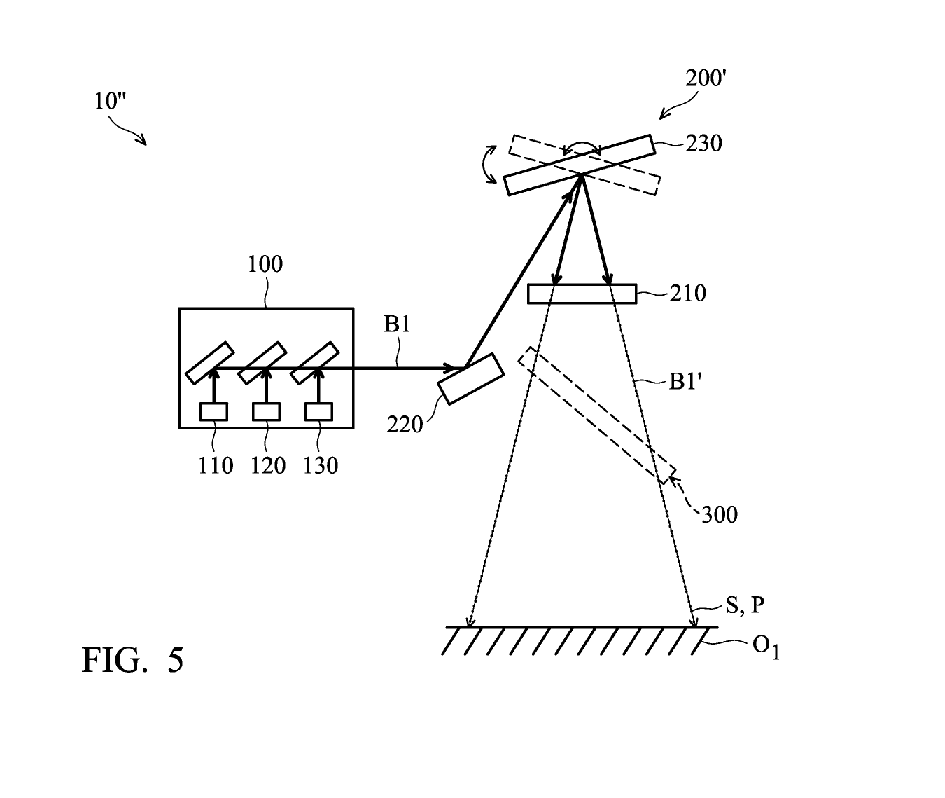

Referring to FIG. 5, a schematic view of an image-projection module 10″ in third embodiment is shown. In FIG. 5, similar elements which are shown in FIG. 4 are provided with the same reference numbers, and the features of similar elements are not repeated in the interests of brevity. Differences between the image-projection module 10″ and the image-projection module 10′ includes that the light-path switching unit 300 is arranged to be moveable in the image-projection module 10″. The laser light beam B1 from the light source assembly 100 is converted by the light polarization switching element 210 to a polarized laser light beam B1′ and projected to the light-path switching unit 300. And the polarized laser light beam B1′ with different polarizing directions is projected on the first desired target O1 if the light-path switching unit 300 is removed from the optical path.

In the above mentioned embodiments, when the light-path switching unit 300 is positioned on the optical path and the light polarization switching element 210 is controlled by the control assembly 400, the image-projection module 10″ can be operated in a single direction projection mode to project the image in the first projection direction, or the image-projection module 10″ can be operated in a single direction projection mode to project the image in the second projection direction, or the image-projection module 10″ can be operated in a bi-directional projection mode to project the image in the first projection direction and the second projection direction. On the other hand, when the light-path switching unit 300 is removed from the optical path of the polarized laser light beam B1′ and the light polarization switching element 210 is controlled by the control assembly 400 to be alternately switched between a first operating mode and a second operating mode at a predetermined switching frequency, the polarized laser light beam B1′ with the first polarizing direction and the polarized laser light beam B1′ with the second polarizing direction are alternately produced. The polarized laser light beam B1′ with different polarizing directions are projected to the same desired target (e.g., the first desired target). As a result, a 3-dimensional image-projection is realized.

In the embodiment of the present disclosure, with the control of the light polarization switching element 210 by the control assembly 400 and through changing the position of the moveable light-path switching unit 300 in the image-projection module 10″, the image-projection module 10″ can be operated in a single direction projection mode to project the image in the first projection direction, or the image-projection module 10″ can be operated in a single direction projection mode to project the image in the second projection direction, or the image-projection module 10″ can be operated in a bi-directional projection mode to project the images in the first projection direction and the second projection direction, or the image-projection module 10″ can be operated in a 3-dimensional projection mode.

An image-projection module is provided in the present disclosure. The image-projection module converts a laser light beam to a polarized laser light beam with a single polarizing direction by a light polarization switching element. In addition, the image-projection module redirects the polarized laser light beam along different optical paths according the polarizing direction of the polarized laser. Therefore, the laser light beam produced by the image-projection module can be projected along different projection paths. The image-projection module is able to be operated in different operation modes in different situations, and the usability of the image-projection module is improved.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image-projection module, comprising:
a light source assembly, configured to emit a laser light beam;
a light polarization switching element, configured to enable the laser light beam passing therethrough to selectively have a first polarizing direction or a second polarizing direction; and
a light-path switching unit, configured to receive the laser light beam from the light polarization switching element and determine a projection path of the laser light beam according to the polarizing direction of the laser light beam.

2. The image-projection module as claimed in claim 1, wherein when the laser light beam is in the first polarizing direction, the laser light beam impinging the light-path switching unit has a first projection path, and when the laser light beam is in the second polarizing direction, the laser light beam impinging the light-path switching unit has a second projection path.

3. The image-projection module as claimed in claim 1, further comprising a control assembly, configured to control the light polarization switching element at a switching frequency and enable the laser light beam passing through the light polarization switching element to have the first polarizing direction or the second polarizing direction alternately according to the switching frequency, and the laser light beam impinging the light-path switching unit alternately has a first projection path or a second projection path, and the image-projection module is correspondingly operated in a bi-directional projection mode having the first projection direction and the second projection direction.

4. The image-projection module as claimed in claim 3, further comprising a light scanning element configured to drive the laser light beam to scan in a two-dimensional direction, wherein the switching frequency corresponds to a time period during which the light scanning element scans a whole image frame in the two-dimensional direction by the laser light beam.

5. The image-projection module as claimed in claim 1, further comprising a light scanning element configured to drive the laser light beam to scan in a two-dimensional direction.

6. The image-projection module as claimed in claim 1, wherein the light-path switching unit comprises a polarizing beam splitter.

7. The image-projection module as claimed in claim 1, wherein the light polarization switching element is a liquid-crystal panel comprising a liquid-crystal layer, wherein with the control of the orientation of liquid-crystal cells in the liquid-crystal layer, the laser light beam passing through the liquid-crystal panel has the first polarizing direction or the second polarizing direction.

8. The image-projection module as claimed in claim 1, further comprising a control assembly configured to control the light polarization switching element to enable the laser light beam passing through the light polarization switching element to be kept in the first polarizing direction or the second polarizing direction, and the laser light beam impinging the light-path switching unit correspondingly has a first projection path or a second projection path, and the image-projection module is correspondingly operated in a single direction projection mode having a first projection direction or operated in a single direction projection mode having a second projection direction.

9. An image-projection module, comprising:
a light source assembly, configured to emit a laser light beam;
a light polarization switching element, configured to enable the laser light beam passing therethrough to selectively have a first polarizing direction or a second polarizing direction; and
a control assembly, configured to control the light polarization switching element at a switching frequency, wherein the laser light beam passing through the light polarization switching element is polarized in the first polarizing direction or the second polarizing direction according to the switching frequency.

10. The image-projection module as claimed in claim 9, further comprising a light-path switching unit, configured to receive the laser light beam from the light polarization switching element and determine a projection path of the laser light beam according to the polarizing direction of the laser light beam.
